(19) United States
(12) Patent Application Publication
(10) Pub. No.: US 2023/0294522 A1
(43) Pub. Date: Sep. 21, 2023

(54) CONTROL SYSTEM FOR AN ELECTRIC VEHICLE COMPRISING IN-WHEEL MOTORS

(71) Applicant: E-TRACTION EUROPE B.V., Apeldoorn (NL)

(72) Inventors: Gerrit Jan KWINTENBERG, Apeldoorn (NL); Bas BROEKHUIS, Apeldoorn (NL)

(21) Appl. No.: 18/040,057

(22) PCT Filed: Jul. 26, 2021
(86) PCT No.: PCT/NL2021/050477

§ 371 Date: Jan. 31, 2023

(30) Foreign Application Priority Data
Jul. 31, 2020 (NL) 2026182

(51) Int. Cl. B60L 15/20; B60K 1/02; B60K 17/356; B60R 16/023; B62D 65/02

(52) U.S. Cl. CPC B60L 15/20; B60K 1/02; B60K 17/356; B60R 16/0231; B62D 65/02

(57) ABSTRACT

The invention relates to a control system (7,9) for an electric vehicle (1), the vehicle having a chassis (2) which is connectable to two or to at least four in-wheel motors (M1,M2,M3,M4), the control system comprising:—a control unit (9,PCM) with at least two signal terminals (SL1,SL2) that can each be coupled to a group of in-wheel motors (M1,M2;M3,M4;M5,M6;M7,M8) and—a power distribution unit (7,PDU) connected to the control unit, provided with at least two power lines (PL1, PL2) and adapted to be connected with an inlet to a power source and with each power line (PL21,PL2) to a group of motors (M1,M2;M3,M4;M5,M6;M7,M8) for supplying power to the group. The control unit (PCM) comprises a memory with a look-up table in which: when two motors (M1,M2) are used on the vehicle (1), each motor (M1,M2) is assigned to a respective signal terminal (SL1, SL2) and to a respective power line (PL1,PL2), and when four motors (M1,M2,M3 and M4) are used on the vehicle, a first group of two motors (M1,M2) is assigned to the first signal terminal (SL1) and to the first power line (PL1) and a second group of two motors (M3,M4) is assigned to the second signal terminal (SL2) and to the second power line (PL2).

### FIELD

The invention relates to a control system for an electric vehicle, the vehicle having a chassis which is connectable to two, four, six or eight in-wheel motors. The invention also relates to an electric vehicle comprising such a control system and to a method of manufacture of an electric vehicle.

### BACKGROUND

From US 2014/025716 an electric vehicle is known having two independent electric motors, each with different torque characteristics. A torque and traction controller receives driver signals generated by a steering sensor, an acceleration sensor, brake sensor and gear selection sensor and in coupled to two power control modules for determining the power that each power control module supplies to its respective motor.

U.S. Pat. No. 5,973,463 describes a vehicle having two in-wheel motors. The right and the left rear in-wheel motors are each operated via a separate inverter and individual motor controller that is connected to the central vehicle controller that also receives individual wheel speed data.

It is an object of the present invention to provide a controller for an electric vehicle with at least two in-wheel motors which can be used on vehicles having different numbers of motors. It is a further object to provide a controller that provides redundant operation and which provides stable and safe driving conditions in case of interruption of the data exchange with or power supply to a specific wheel, or failure or malfunctioning of one of the in-wheel motors.

It is again an object of the invention to provide electric vehicles that can be easily provided with different sets of in-wheels motors that can be accurately and reliably serviced and controlled via the control system of the invention.

### SUMMARY OF THE INVENTION

Hereto a control system according to the invention comprises:
a control unit with at least two signal terminals that

in case of two in-wheel motors can each be connected to a respective motor and

in case of four, six or eight in-wheel motors, can each be connected to a group of in-wheel motors, each group comprising at least one pair of motors situated on the same transverse axis,
a power distribution unit connected to the control unit, provided with at least two power lines and adapted to be connected with an inlet to a power source and with each power line,

in case of two in-wheel motors, to a respective motor, and in case of four, six or eight in-wheel motors, to a respective group of motors, for supplying power to each group,

wherein the control unit comprises a memory with a look-up table in which:

when two motors are used on the vehicle, each motor is assigned to a respective signal terminal and to a respective power line, and

when four motors are used on the vehicle,

a first group of two motors is assigned to the first signal terminal and to the first power line and a second group of two motors is assigned to the second signal terminal and to the second power line.

By connecting each group of motors to a respective signal line, failure on one signal line resulting in loss of communication, will result in loss of drive and brake power of the same amount of in-wheel motors on the left side and the right side of the vehicle. This improves the dynamic stability of the vehicle as no imbalance in torque occurs. The same redundancy is achieved with the power lines. If a high voltage related problem would occur in a single DC power line causing a high voltage fuse to open and to cause loss of drive and brake torque of the connected in-wheel motors, this would have an effect on the same number of in-wheel motors on the left and on the right side of the vehicle keeping a balanced torque distribution and control.

For the power lines, a hard-wired connection of the in-wheel motors to the power distribution unit is provided. The control unit can interact with the power distribution unit for each motor configuration comprising 2, 4, 6 or 8 wheels using the same hardwired connection. The control unit utilizes a single set of control signals for each group of in-wheel motors. Therefore, connecting one or more additional in-wheel motors to the same group does not require an increase in the number of control signals. The design remains similar for different configurations of groups of in-wheel motors. No additional wires are needed between the control unit and the power distribution unit. This simplifies the design of the system across different configurations.

The-control unit knows, based on the configuration, where the in-wheel motor communication is expected through the fixed look up table. Feedback data from each in-wheel motor to the control unit during the pre-charge cycle, is communicated through a CANbus and is managed with software.

In a control system that controls six motors on the vehicle, a first group of two motors is assigned to the first signal terminal and to the first power line and a second group of four motors is assigned to the second signal terminal and to the second power line. Alternatively, the first group may comprise four motors, and the second group two. For eight motors, a first group of four motors is assigned to the first signal terminal and to the first power line and a second group of four motors is assigned to the second signal terminal and to the second power line. Alternatively, the first group may comprise two motors, and the second group six, or the first group may comprise 6 motors and the second group 2.

In an embodiment of a control system according to the invention, to each wheel position on the vehicle, a unique wheel identifier is assigned, the control unit being adapted to exchange data with a predetermined wheel by sending and receiving information using the corresponding wheel identifier. The wheel identifiers may for each wheel on the same side of the vehicle comprise an even or an odd number, the identifier numbers increasing counting up from a front or from a rear chassis position.

The unique assignment of wheel numbers over the complete system will ensure that operational mistakes, such as connecting an in-wheel motor to the incorrect signal terminal, will cause an inactivated in-wheel motor.

In an embodiment of a control system according to the invention, in a pre-charge procedure of a predetermined wheel, the control unit controls the power supply from the Power distribution unit (PDU) to the predetermined wheel or group of wheels, and receives feedback data relating to the pre-charging procedure from the wheel(s). In the pre-charging procedure, a feedback value is sent from the in-wheel motor or group of motors to the power control unit to check if the process has been executed successfully. Due to the similar layout of the data lines and the power lines, it is ensured that the redundancy between the power lines and data lines is optimal.

The control unit according to the invention is connectable to a service terminal for exchange of data with a predetermined wheel. The service terminal may comprise a laptop or hand held terminal with software to interact with the wheels for diagnostic purposes. This diagnostic service application may be used by different disciplines, such as engineering, production, testing or service and interacts with the control unit and with the in-wheel motors. Actions that are carried out may be software updates, calibration of parameters, execution of test procedures or the extraction of diagnostic information. This software interfaces with the system for instance through a USB to CANbus interface.

The control unit may comprise CANbus gateway functionality allowing CANbus access to an individual in-wheel motor by means of the vehicle CANbus. The CANbus traffic from the diagnostic service terminal is routed from the vehicle CANbus towards the correct local CANbus where the desired in-wheel motor is located. This provides easy access for the service engineer, since there is only a single access point for diagnostics on the control system module. The distribution of the in-wheel motors is known to the gateway function for performing the correct routing through the use of the look-up table that is set by the wheel configuration and that hence determines where the information should be routed towards.

### BRIEF DESCRIPTION OF THE DRAWINGS

An embodiment of a control system according to the invention will, by way of non-limiting example, be explained in detail with reference to the accompanying drawings. In the drawings:

FIG. 1 shows a schematic lay out of an electric vehicle having six in wheel motors and a control system according to the invention,

FIGS. 2a and 2b show the layout of the data lines and power lines for a vehicle having two in-wheel motors,

FIGS. 3a and 3b show the layout of the data lines and power lines for a vehicle having four in-wheel motors,

FIGS. 4a and 4b show the layout of the data lines and power lines for a vehicle having six in-wheel motors, and

FIGS. 5a and 5b show the layout of the data lines and power lines for a vehicle having eight in-wheel motors.

### DETAILED DESCRIPTION OF THE INVENTION

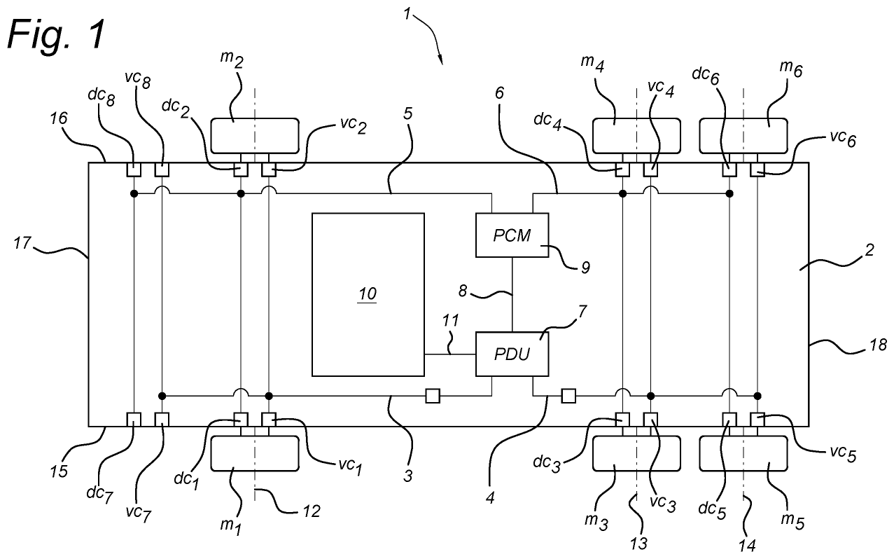

FIG. 1 shows an electric vehicle 1 with a chassis 2 with a front 17 and rear 18, and six in-wheel motors M1-M6. Each in-wheel motor M1-M6 can be of the type as described in WO2019/017788, filed in the name of the applicant. Each in-wheel motor is connected via a HV connector vc1-vc6 to HV power lines 3,4. The high voltage power lines 3,4 are connected to a power distribution unit PDU 7 that is connected via a power line 11 to an electric supply system, such as a HV DC battery 10. The Motors M1-M6 are via data connectors dc1-dc6 connected to data lines 5,6, such as a CANbus, that are connected to a control unit formed by Powertrain Control Module, or control unit, PCM 9 .The control module PCM 9 is with an input (not shown) arranged to receive driver signals generated by a steering sensor, an accelerator pedal sensor, brake pedal sensor and gear selection sensor and is with an output connected to the PDU 7 via a control line 8. Under control of the PCM 9, the PDU 7 supplies a high voltage to each motor M1-M8 via the power lines 3,4. Each motor M1-M6 comprises an inverter that converts the high voltage input to a voltage with proper waveform and phase for driving of the stator coils. Data about its state (e.g. temperature) and performance (e.g. torque and rotational speed) are sent by each motor M1-M6 to the PCM 9 through the CANbus data lines 5,6.

The motors are arranged in pairs M1,M2; M3,M4 and M5, M6, wherein the motors in a pair are aligned along the axes 12,13,14. The motors M1,M2 near the front 17 are connected to the power line 3 and to the data line 5. The motors M3-M6 are connected to the power line 4 and to the data line 6. The chassis 2 is provided with two wheel connect positions 15, 16, with connectors vc7,dc7 and vc8, dc8 for optionally connecting to a further pair of in-wheel motors. The chassis 2 may be formed of a rigid body in a single piece or can be formed of multiple segments that may for instance be interconnected via an articulation joint.

FIGS. 2a and 2b show a configuration of two in-wheel motors M1, M2 connected to PCM 9 via signal lines SL1, SL2 and to PDU 7 via power lines PL1, PL2.

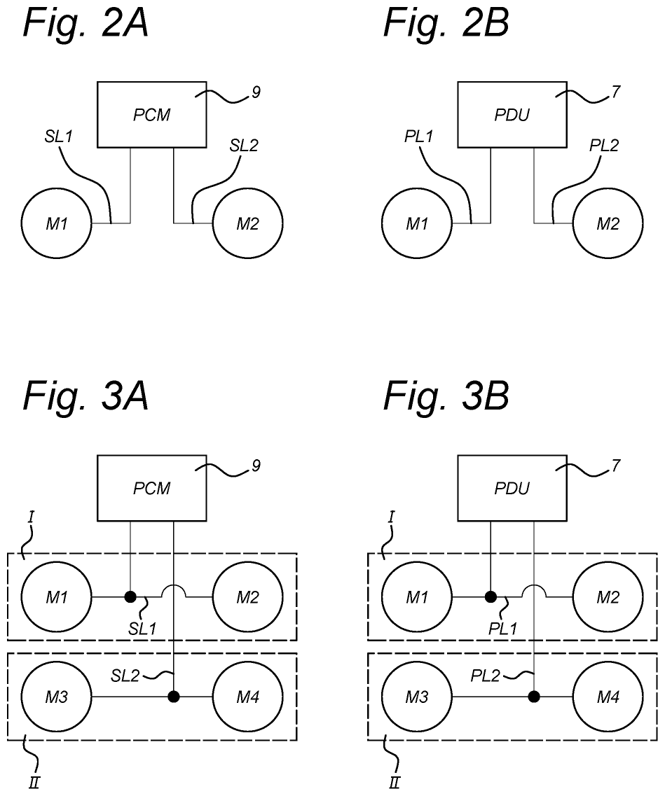

FIGS. 3a and 3b show a configuration of two groups of in-wheel motors, in which group I is formed by motors M1,M2, and is connected to the PCM 9 via signal line SL1. Group II includes motors M3, M4 and is connected to PCM 9 via signal line SL2. As can be seen in FIG. 3b, the configuration of the motors connected to the PDU 7 via the power lines PL1, PL2 is the same as the configuration of the motors connected to the PCM 9 via the signal lines SL1, SL2. Motors M1,M2 in group I are connected to the PDU 7 via power line PL1, and motors M3,M4 in group II are connected to the PDU 7 via power line PL2.

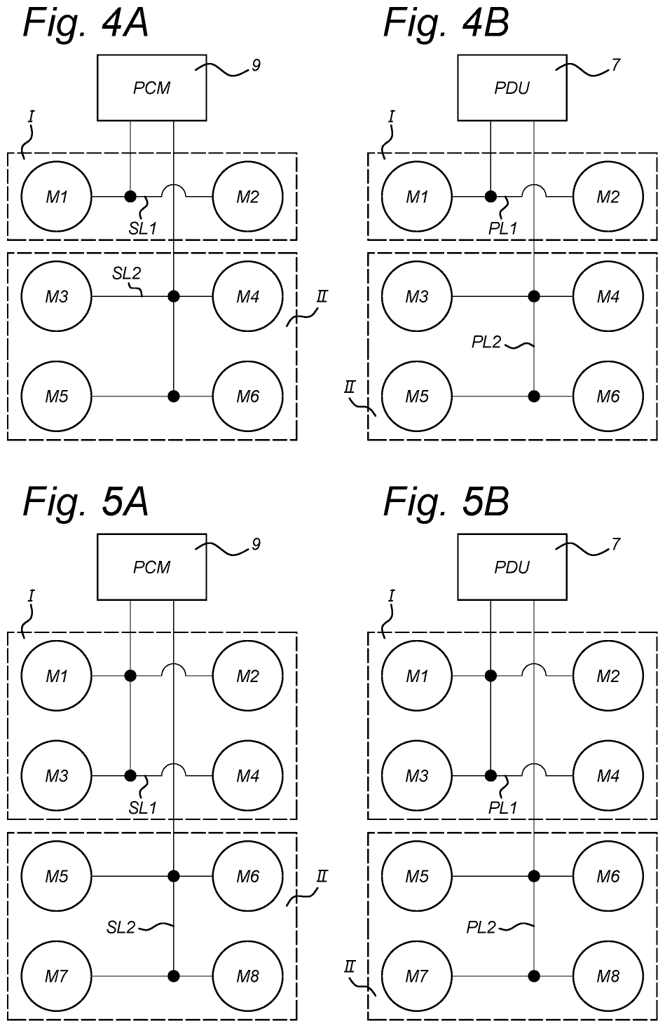

In the embodiment shown in FIGS. 4a and 4b, group I comprises two motors M1,M2 and group II comprises four motors M3-M6. In the embodiment of FIGS. 5a and 5b each group I and II comprises four in-wheel motors.

The control system formed by the PDU 7 and PCM 9 can be connected to 2, 4, 6, or 8 in-wheel motors on a vehicle. The use of groups of in-wheel motors offers redundancy to the vehicle since a single failure of an in-wheel motor allows the vehicle to continue operation with limited performance. This redundancy is further extended by the physically separated communication lines (CANbus) SL1, SL2 of the in-wheel motors towards the central control module PCM 9, and the physically separated DC-Link PL1, PL2 of the in-wheel motor towards the power distribution unit PDU 7.

The PDU 7 comprises high voltage fuses, main contactors and pre-charge circuits.

For the configurations using 4, 6 or 8 motors as shown in FIGS. 3a-5b, the higher system complexity and therefore higher cost associated with redundancy is limited by obtaining a good balance between system complexity and redundancy by the two-fold redundancy.

To identify the in-wheel motors M1-M8, each one is assigned a number with the following conventions:
Uneven wheel numbers are always located on the left side of the vehicle 1.
Even wheel numbers are always located on the right side of the vehicle 1.
The wheel numbers are enumerated in a vehicle front 17 (see FIG. 1) to rear 18 pattern.

Because the in-wheel motors are distributed as illustrated in FIGS. 2a-5a, if a problem would occur on a single communication bus SL1, SL2, causing loss of communication and therefore loss of drive

and brake torque of the connected in-wheel motors, this would have an effect on the same number of in-wheel motors on the left and right side of the vehicle. This improves the dynamic stability of the vehicle.

The in-wheel motor number of motors M1-M8 is directly linked to the identification of the communication messages that are exchanged between the in-wheel motor and the PCM 9. The strict unique assignment of wheel numbers over the complete system will ensure that operational mistakes, e.g. connecting an in-wheel motor to the incorrect communication channel, will cause an inactivated in-wheel motor. The assignment of in-wheel motors M1-M8 to the rechargeable energy storage system 10 is organized by the two physically separated DC-Link channels PL1, PL2, as shown in FIGS. 2b-5b.

The advantage of the similarity in distribution of in-wheel motors towards the DC-Links PL1,PL2 is threefold:

Firstly, if high voltage related problem would occur on a single DC-Link channel, hence causing the high voltage fuse to open and therefore loss of drive and brake torque of the connected in-wheel motors, this has an effect on the same number of in-wheel motors on the left and right side of the vehicle. This improves the dynamic stability of the vehicle.

Secondly, there is a relation between the communication from the PCM 9 towards the in-wheel motor and the DC-Link PL1, PL2 of that in-wheel motor trough the pre-charge procedure. The pre-charge procedure requires a feedback value to be sent from the in-wheel motor to the PCM 9 to check if the process has been executed successfully. Due to the similar distribution of the motors with respect to the communication channels SL1, SL2 and with respect to the DC-Link PL1, PL2, it is ensured that the redundancy between both communication and power channels is optimal.

Thirdly, The PCM 9 comprises CANbus gateway functionality that is used to allow CANbus access to an individual in-wheel motor by means of the vehicle CANbus. The CANbus traffic from the diagnostic service application is routed from the vehicle CANbus towards the correct private CANbus where the pre-determined in-wheel motor is located. This will ease the accessibility for the service engineer, since there is one single access point for diagnostics of the control system.

The distribution of in-wheel motors M1-M8 over the communication channels SL1-SL2 needs to be known by the gateway function in order to perform the correct routing, that is carried out on the basis of the look-up table, an example of which is given below.

From a central control perspective there is a hardwired connection 8 from the PCM 9 to the PDU 7 for control of the high voltage contactors. The PCM 9 can control the PDU for each configuration (2, 4, 6 and 8 wheels) using the same hardwired connection carrying multiple signals. This simplifies the design of the system across different configurations.

The PCM 9 will need to know based on the configuration according to FIGS. 2a-5a and 2b-5b, on which data line SL1, SL2 in-wheel motor communication is expected for a given motor number, by a fixed mapping table. Also the in-wheel motor DC-Link precharge feedback information needs to be data fused to each channel by the same fixed mapping table. During the pre-charging procedure for each motor or group of motors, the voltage will slowly rise to reach a pre-determined level. When this level is reached, the main contactor of the pre-charging circuit can be closed without the risk of damage to the main contactor.

In the table below, a mapping is given that is stored in the memory of the PCM 9.

| Motor | Configuration of | | Configuration of | | Configuration of | | Configuration of | |
|---|---|---|---|---|---|---|---|---|
| number | FIG. 2a /FIG. 2b | | FIG. 3a/FIG. 3b | | FIG. 4a/FIG. 4b | | FIG. 5a/FIG. 5b | |
| M1 | SL1 | PL1 | SL1 | PL1 | SL1 | PL1 | SL1 | PL1 |
| M2 | SL2 | PL2 | SL1 | PL1 | SL1 | PL1 | SL1 | PL1 |
| M3 | | | SL2 | PL2 | SL2 | PL2 | SL1 | PL1 |
| M4 | | | SL2 | PL2 | SL2 | PL2 | SL1 | PL1 |
| M5 | | | | | SL2 | PL2 | SL2 | PL2 |
| M6 | | | | | SL2 | PL2 | SL2 | PL2 |
| M7 | | | | | | | SL2 | PL2 |
| M8 | | | | | | | SL2 | PL2 |

1. A control system (7,9) for an electric vehicle (1), the vehicle having a chassis (2) which is connectable to two, four, six or eight in-wheel motors (M1-M8), the control system comprising:
a control unit (9,PCM) with at least two signal terminals (5,6; SL1,SL2) that in case of two in-wheel motors (M1,M2) can each be connected to a respective motor and in case of four, six or eight in-wheel motors, can each be connected to a group of in-wheel motors (M1,M2;M3,M4;M5,M6;M7,M8), each group comprising at least one pair of motors situated on the same transverse axis (12, 13, 14),
a power distribution unit (7,PDU) connected to the control unit (9,PCM), provided with at least two power lines (3,4; PL1, PL2) and adapted to be connected with an inlet to a power source (10) and via each power line (3,4; PL1,PL2) to
a respective motor in case of two in-wheel motors (M1,M2) on the chassis and
a respective group of motors (M1,M2;M3,M4;M5,M6;M7,M8) in case of four, six or eight in-wheel motors on the chassis, for supplying power to each group,
wherein the control unit (9,PCM) comprises a memory with a look-up table defining at least two configuration data sets,
the first configuration data set assigning for two motors (M1,M2) on the vehicle (1) each motor (M1,M2) to a respective signal terminal (5,6; SL1,SL2) and to a respective power line (3,4; PL1,PL2), and
the second configuration data set assigning for four motors (M1,M2,M3,M4) on the vehicle, a first group of two motors (M1,M2) to the first signal terminal (5,SL1) and to the first power line (3, PL1) and a second group of two motors (M3,M4) to the second signal terminal (6,SL2) and to the second power line (4,PL2).

2. The control system (7,9) according to claim 1, wherein the look-up table comprises a third configuration data set that assigns for six motors (M1,M2,M3,M4,M5,M6) on the vehicle (1), a first group of two motors (M1,M2) to the first signal terminal (SL1) and to the first power line (PL1) and a second group of four motors (M3-M6) to the second signal terminal (SL2) and to the second power line (PL2).

3. The control system (7,9) according to claim 1, wherein the look-up table comprises a fourth configuration data set that assigns for eight motors (M1,M2,M3,M4,M5,M6,M7,M8) on the vehicle (1), a first group of four motors (M1-M4) to the first signal terminal (SL1) and to the first power line (PL1) and a second group of four motors (M5-M8) to the second signal terminal (SL2) and to the second power line (PL2).

4. The control system (7,9) according to claim 1, wherein in the control unit (PCM 9) to each wheel position on the vehicle, a wheel identifier is assigned, the control unit (PCM 9) being adapted to exchange data with a predetermined wheel (M1-M8) by sending and receiving of the predetermined wheel identifier.

5. The control system (7,9) according to claim 4, wherein the wheel identifiers for each wheel on the same side of the vehicle (1) comprise an even or an odd number, the identifier numbers increasing counting up from a front or from a rear chassis position (17, 18).

6. The control system (7,9) according to claim 1, wherein in a pre-charge procedure of a predetermined wheel, the control unit (PCM 9) controls the power supply from the Power distribution unit (POU 7) to the predetermined wheel, and receives data from the predetermined wheel of the voltage level at the wheel.

7. The control system (7,9) according to claim 1, wherein the control unit (PCM 9) is connectable to a service terminal for exchange of data with a predetermined wheel.

8. An electric vehicle (1) comprising two, four, six or eight in-wheel motors (M1-M8) and a control system (7,9) according to claim 1, wherein in the control unit (9,PCM) the number of in-wheel motors attached to the vehicle has been set and the signal terminals (5,6; SL1,SL2) and the power lines (3,4; PL1,PL2) have been assigned in accordance with the number of motors and each signal line and power line is connected to a respective in-wheel motor or group of in-wheel motors.

9. A method of manufacturing an electric vehicle comprising the steps of:
providing a chassis (2) with 2, 4, 6 or 8 in-wheel motors and a power source (10),
providing a control system (7,9) with a control unit (9,PCM) and a power distribution unit (7,PDU), the control unit having at least two signal terminals (5,6; SL1, SL2) that are each coupled to a respective in-wheel motor (M1,M2) or to a respective group of in-wheel motors (M1,M2;M3,M4;M5,M6;M7,M8), each group comprising at least one pair of motors situated on the same transverse axis (12, 13, 14),
coupling the power distribution unit (7,PDU) with two outlets via at least two power lines (3,4;PL1, PL2) to a respective in-wheel motor (M1,M2) or to a respective group of motors (M1,M2;M3,M4;M5,M6;M7,M8) for supplying power to each motor or group of motors, and with an inlet connected to the power source (10),
inputting the number of motors on the vehicle into the control system (7,9),
wherein the control unit (9,PCM) comprises a memory with a look-up table defining at least two configuration data sets,
the first configuration data set assigning for two motors (M1,M2) on the vehicle (1) each motor (M1,M2) to a respective signal terminal (5,6; SL1,SL2) and to a respective power line (3,4; PL1,PL2), and
the second configuration data set assigning for four motors (M1,M2,M3,M4) on the vehicle,
a first group of two motors (M1,M2) to the first signal terminal (5,SL1) and to the first power line (3,PL1) and a second group of two motors (M3,M4) to the second signal terminal (6,SL2) and to the second power line (4,PL2), and
selecting the configuration data set corresponding to the number of motors.

10. The method according to claim 9, wherein the look-up table comprises a third configuration data set that assigns for six motors (M1,M2,M3,M4,M5,M6) on the vehicle (1) a first group of two motors (M1,M2) to the first signal terminal (SL1) and to the first power line (PL1) and a second group of four motors (M3-M6) to the second signal terminal (SL2) and to the second power line (PL2), the method further comprising the step of connecting six motors (M1,M2,M3,M4,M5 and M6) to the chassis, wherein a first group of two motors (M1,M2) is assigned to the first signal terminal (S 1) and to the first power line (PL1) and a second group of four motors (M3-M6) is assigned to the second signal terminal (SL2) and to the second power line (PL2).

11. The method according to claim 9, wherein the look-up table comprises a fourth configuration data set that assigns for eight motors (M1,M2,M3,M4,M5,M6,M7,M8) on the vehicle (1) a first group of four motors (M1-M4) to the first signal terminal (SL1) and to the first power line (PL1) and a second group of four motors (M5-M8) to the second signal terminal (SL2) and to the second power line (PL2), the method further comprising the step of connecting eight motors (M1,M2,M3,M4,M5,M6,M7,M8) to the chassis, wherein a first group of four motors (M1-M4) is assigned to the first signal terminal (SL1) and to the first power line (PL1) and a second group of four motors (M5-M8) is assigned to the second signal terminal (SL2) and to the second power line (PL2).

12. The control system (7,9) according to claim 2, wherein in the control unit (PCM 9) to each wheel position on the vehicle, a wheel identifier is assigned, the control unit (PCM 9) being adapted to exchange data with a predetermined wheel (M1-M8) by sending and receiving of the predetermined wheel identifier.

13. The control system (7,9) according to claim 12, wherein the wheel identifiers for each wheel on the same side of the vehicle (1) comprise an even or an odd number, the identifier numbers increasing counting up from a front or from a rear chassis position (17, 18).

14. The control system (7,9) according to claim 3, wherein in the control unit (PCM 9) to each wheel position on the vehicle, a wheel identifier is assigned, the control unit (PCM 9) being adapted to exchange data with a predetermined wheel (M1-M8) by sending and receiving of the predetermined wheel identifier.

15. The control system (7,9) according to claim 14, wherein the wheel identifiers for each wheel on the same side of the vehicle (1) comprise an even or an odd number, the identifier numbers increasing counting up from a front or from a rear chassis position (17, 18).

16. The control system (7,9) according to claim 2, wherein in a pre-charge procedure of a predetermined wheel, the control unit (PCM 9) controls the power supply from the Power distribution unit (POU 7) to the predetermined wheel, and receives data from the predetermined wheel of the voltage level at the wheel.

17. The control system (7,9) according to claim 3, wherein in a pre-charge procedure of a predetermined wheel, the control unit (PCM 9) controls the power supply from the Power distribution unit (POU 7) to the predetermined wheel, and receives data from the predetermined wheel of the voltage level at the wheel.

18. The control system (7,9) according to claim 4, wherein in a pre-charge procedure of a predetermined wheel, the control unit (PCM 9) controls the power supply from the Power distribution unit (POU 7) to the predetermined wheel, and receives data from the predetermined wheel of the voltage level at the wheel.

19. The control system (7,9) according to claim 2, wherein the control unit (PCM 9) is connectable to a service terminal for exchange of data with a predetermined wheel.

20. The control system (7,9) according to claim 3, wherein the control unit (PCM 9) is connectable to a service terminal for exchange of data with a predetermined wheel.
